(19) United States
(12) Patent Application Publication
(10) Pub. No.: US 2012/0038310 A1
(43) Pub. Date: Feb. 16, 2012

(54) INRUSH CURRENT CONTROL FOR A MOTOR STARTER SYSTEM

(75) Inventors: Pradeep Kumar Anand, Bangalore (IN); John Kenneth Hooker, Louisville, KY (US); Remesh Kumar Keeramthode, Secunderabad (IN); Brent Charles Kumfer, Farmington, CT (US)

(73) Assignee: GENERAL ELECTRIC COMPANY, Schenectady, NY (US)

(21) Appl. No.: 12/853,748

(22) Filed: Aug. 10, 2010

(51) Int. Cl. H02P 1/26

(52) U.S. Cl. 318/778

(57) ABSTRACT

A motor starter system includes a plurality of switches, and a controller operatively connected to each of the plurality switches. The controller is configured and disposed to selectively activate select ones of the plurality of switches upon detecting a particular phase angle of each of a plurality of phases of a multi-phase electrical source.

### BACKGROUND OF THE INVENTION

The subject matter disclosed herein relates to motor starting systems and, more particularly, to an inrush current control for a motor starting system.

Electrical systems employ contacts to switch a flow of current on and off. Contacts are closed to allow passage of the flow of current and open to stop the flow of current. Generally, the contacts may be used in contactors, circuit-breakers, current interrupters, motor starters, or other electrical devices. A contactor is an electromechanical device designed to switch an electrical load ON and OFF on command. Traditionally, electromechanical contactors are employed to control operation of various electrical loads such as motors, lights and the like. Depending on their rating, electrical contactors are capable of handling various levels of switching currents. When faced with fault currents that greatly exceed the rating, electrical contactors may fail.

Conventional electromechanical contactors typically employ mechanical switches. However, as these mechanical switches tend to switch at a relatively slow speed, predictive techniques are employed in order to estimate occurrence of a zero crossing, often tens of milliseconds before the switching event is to occur, in order to facilitate opening/closing near the zero crossing for reduced arcing. Such zero crossing prediction is prone to error as many transients may occur in this prediction time interval.

As an alternative to slow mechanical and electromechanical switches, fast solid-state switches have been employed in high speed switching applications. As will be appreciated, solid-state switches change between a conducting state and a non-conducting state through controlled application of a voltage or bias. For example, by reverse biasing a solid-state switch, the switch may be transitioned into a non-conducting state. While conventional solid-state switches have the speed to react to zero crossings to mitigate against contact arcing, solid-state switches lack the desired low on-resistance of conventional electromechanical contactors.

Switching currents on or off during current flow may produce arcs, or flashes of electricity, which are generally undesirable. As described above, contactors may switch alternating current (AC) near or at a zero-crossing point where current flow is reduced compared to other points on an alternating current sinusoid. In contrast, direct current (DC) typically does not have a zero-crossing point. As such, arcs may occur at any instance of interruption.

Presently, micro-electrical mechanical system (MEMS) switches are being considered for use in switching systems. Presently, MEMS generally refer to micron-scale structures that for example can integrate a multiplicity of functionally distinct elements, for example, mechanical elements, electromechanical elements, sensors, actuators, and electronics, on a common substrate through micro-fabrication technology. MEMS switches provide a fast response time that is suitable for use in both AC and DC applications. However, MEMS switches are sensitive to arcing. In order to mitigate the arcing, MEMS switches are connected in parallel with a Hybrid Arcless Limiting Technology (HALT) circuit and a Pulse-Assisted Turn On (PATO) circuit. The HALT circuit facilitates arcless opening of the MEMS switches while the PATO circuit facilitates arcless closing of the MEMS switches.

This background information is provided to reveal information believed by the applicant to be of possible relevance to the present invention. No admission is necessarily intended, nor should be construed, that any of the preceding information constitutes prior art against the present invention.

### BRIEF DESCRIPTION OF THE INVENTION

According to one aspect of an exemplary embodiment, a motor starter system includes a plurality of switches, and a controller operatively connected to each of the plurality of switches. The controller is configured and disposed to selectively activate select ones of the plurality of switches upon detecting a particular phase angle of each of a plurality of phases of a multi-phase electrical source.

According to another aspect of the exemplary embodiment, a motor system includes a multi-phase load having a plurality of phase windings, and a motor starter system having a plurality of switches. Each of the plurality of switches is electrically connected to respective ones of the plurality of phase windings. A controller is operatively connected to each of the plurality of switches. The controller is configured and disposed to selectively activate select ones of the plurality of switches upon detecting a particular phase angle of each of a plurality of phases of a multi-phase electrical source.

According to another aspect of the invention, a method of operating a motor starter system having a plurality of switches connected between a multi-phase load having a plurality of phase windings and a multi-phase electrical supply including a plurality of phases includes sensing a phase angle of each of the plurality of phases, and selectively activating select ones of the plurality of switches based on a predetermined phase angle of each of the plurality of phases.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is block diagram illustrating a motor system including a motor starter system having a plurality of micro-electromechanical system (MEMS) switch systems in accordance with an exemplary embodiment;

FIG. 2 is a schematic diagram of a motor system including a motor starter system

FIG. 3 is a schematic diagram of the motor starter system of FIG. 2 including a plurality of MEMS switch systems in accordance with an exemplary embodiment; and

FIG. 4 is a schematic diagram of a MEMS switch system in accordance with an exemplary embodiment.

The detailed description explains embodiments of the invention, together with advantages and features, by way of example with reference to the drawings.

### DETAILED DESCRIPTION OF THE INVENTION

Micro-electromechanical system (MEMS) switches employed in motor starter are arranged include a number or MEMS switch systems connected in series (m) and a number of MEMS switch systems connected in parallel (n) to form an (m)×(n) array. The number of MEMS switch systems connected in series (m) is dependent upon voltage rating for a single MEMS switch and a worst possible voltage level possible for the array during a surge. The number of MEMS switches connected in parallel (n) is dependent upon, in general, the current rating of a single MEMS switch and a worst possible long duration current through the array of MEMS switches. The worst possible long duration current through the array of MEMS switches is roughly equivalent to a short circuit fault condition during motor start up. Staring a motor with an existing short circuit results in a high in-rush current and a short circuit current, the combination representing the worst possible long duration current through the array of MEMS switches. Thus, motor in-rush current plays a role in MEMS circuit design. That is, minimizing in-rush current will reduce the number of MEMS switches in a circuit thereby reducing costs and overall complexity of the MEMS circuit.

As used herein, the term “zero crossing” should be understood to represent a point when a sign of a function changes, e.g., from positive to negative, represented by a crossing of an axis of a graph of the function. The term “phase” should be understood to mean one of a plurality of alternating currents that reach a peak value at a different time. The term “phase angle” should be understood to mean an angular component of one of a plurality of phases. The term “phase winding” should be understood to mean one of a plurality of individual conductor windings on a stator of a polyphase motor or generator.

Presently, MEMS generally refer to micron-scale structures that for example can integrate a multiplicity of functionally distinct elements, for example, mechanical elements, electromechanical elements, sensors, actuators, and electronics, on a common substrate through micro-fabrication technology. It is contemplated, however, that many techniques and structures presently available in MEMS devices will in just a few years be available via nanotechnology-based devices, for example, structures that may be smaller than 100 nanometers in size. Accordingly, even though example embodiments described throughout this document may refer to MEMS-based switching devices, it is submitted that the embodiments should be broadly construed and should not be limited to micron-sized devices.

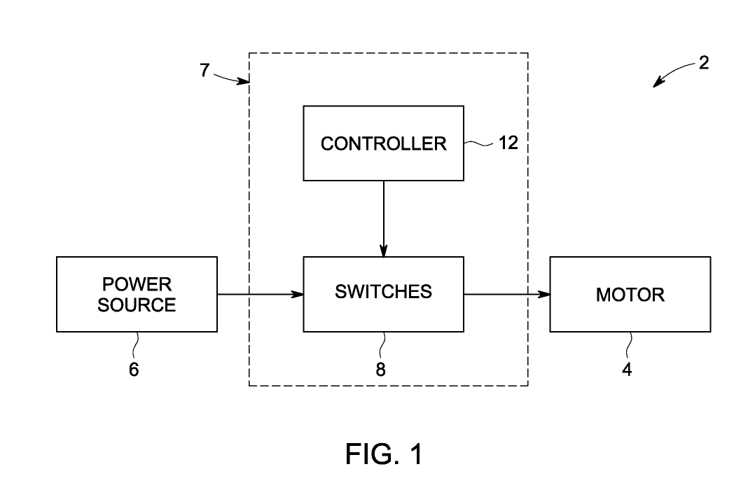

FIG. 1 illustrates a motor system 2 in accordance with an exemplary embodiment. Motor system 2 includes a multi-phase electrical load 4 operatively coupled to a multi-phase power source 6 through a motor starter system 7. Motor starter system 7 includes a plurality of switches indicated generally at 8. In accordance with an exemplary embodiment, motor starter system 7 includes a controller 12 is operatively connected to switches 8. As will become more readily apparent below, controller 12 detects a phase angle associated with each of a plurality of phases of multi-phase power source 6. Based on a particular phase angle for each of the plurality of phases, controller 12 selectively actives select ones of the plurality of switches 8 by providing gate drive pulses.

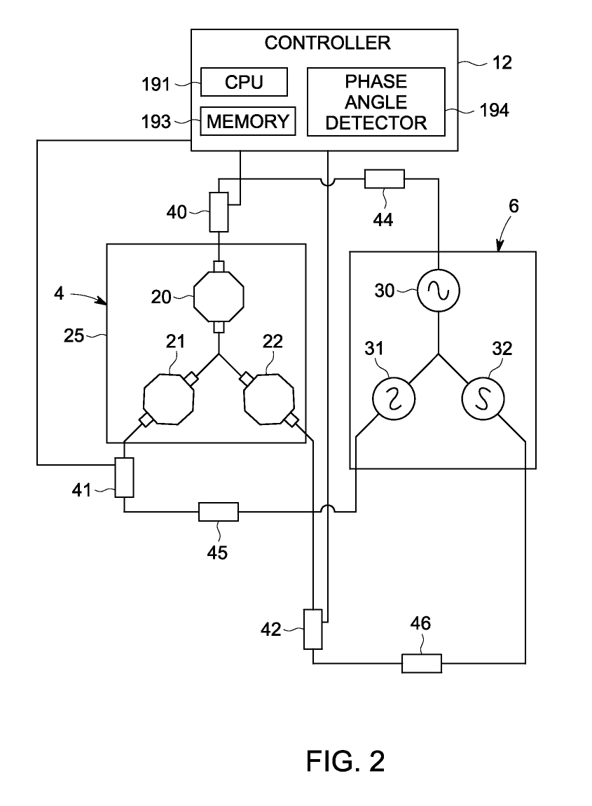

As best shown in FIG. 2, multi-phase load 4 includes a first phase winding 20, a second phase winding 21, and a third phase winding 22 thereby defining a three-phase load. In accordance with one aspect of the exemplary embodiment, multi-phase load 4 takes the form of a three-phase electric motor 25. Electric motor 25 is electrically connected to multi-phase power source 6 through motor starter system 7. As shown, multi-phase power source 6 includes a first phase 30, a second phase 31 and a third phase 32. More specifically, first phase winding 20 is electrically connected to first phase 30 through a first switch 40, second phase winding 21 is electrically connected to second phase 31 through a second switch 41 and third phase winding 22 is electrically connected to third phase 32 through a third switch 42. In addition, a first voltage sensor 44 is arranged between first switch 40 and first phase 30, a second voltage sensor 45 is arranged between second switch 41 and second phase 31, and a third voltage sensor 46 is arranged between third switch 42 and third phase 32.

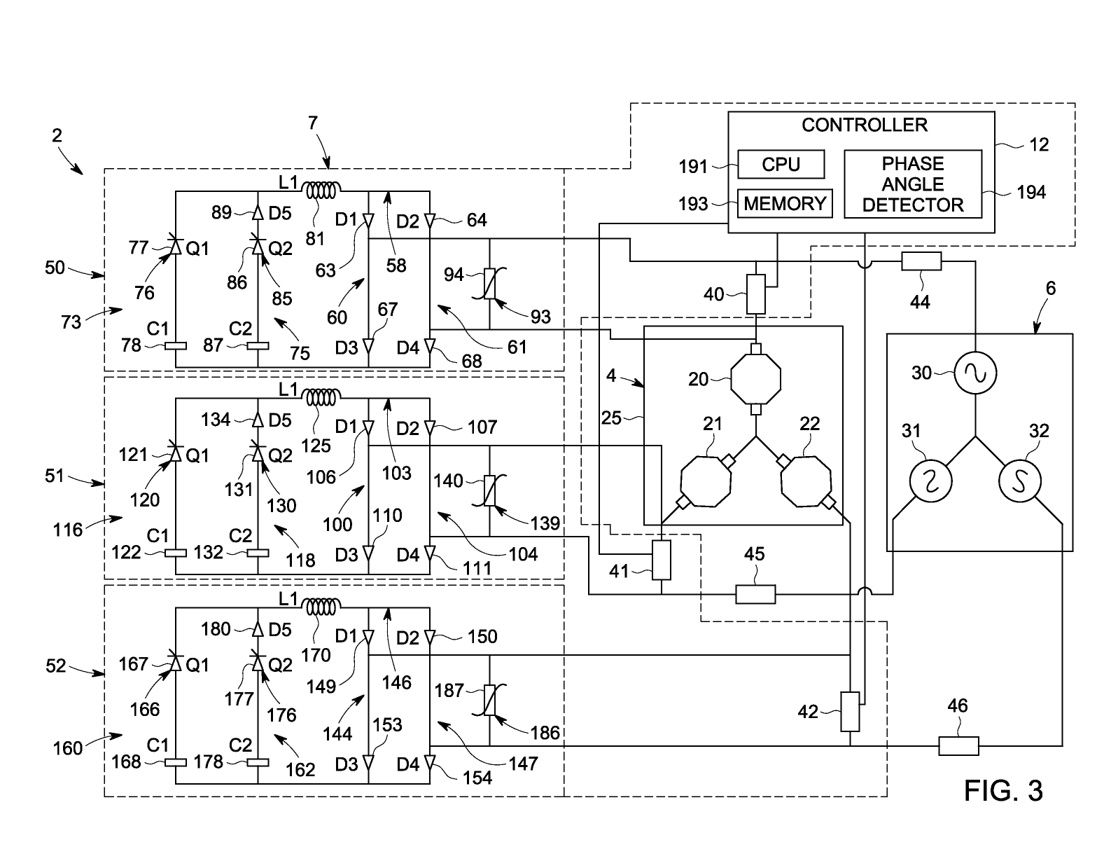

In accordance with an exemplary embodiment illustrated in FIG. 3, each switch 40-41 takes the form of a MEMS switch system. Each MEMS switch system 40, 41, and 42 is connected to a corresponding Hybrid Arcless Limiting Technology/Pulse Activated Turn-On (HALT/PATO) circuit 50, 51, and 52. As used herein, the term “MEMS switch system” is used to represent a single MEMS switch or an array of MEMS switches arranged in a series configuration (m), a parallel configuration (n), or a series/parallel configuration (m×n).

In the exemplary embodiment shown, HALT/PATO circuit 50 includes a balanced diode bridge 58. Balanced diode bridge 58 includes a first branch 60 and a second branch 61. As used herein, the term “balanced diode bridge” is used to represent a diode bridge that is configured such that voltage drops across both the first and second branches 60, 61 are substantially equal. First branch 60 of balanced diode bridge 58 includes a first diode (D1) 63 and a second diode (D2) 64. In a similar fashion, second branch 61 of balanced diode bridge 58 includes a third diode (D3) 67 and a fourth diode (D4) 68 operatively coupled together. When conducting, balanced diode bridge 58 establishes an equipotential point between a cathode (not separately labeled) of first diode (D1) 63 and a cathode (not separately labeled) of second diode (D2) 64. Of course, the equipotential point could also be between an anode (not separately labeled) of third diode (D3) 67 and an anode (not separately labeled) of fourth diode (D4) 68. The equipotential point ensures that, during opening and closing, voltage across MEMS switch system 40 remains low (e.g., less than 1 volt).

HALT/PATO circuit 50 is also shown to include a HALT circuit portion 73 connected in parallel to a PATO circuit portion 75. HALT circuit portion 73 includes a HALT switch 76 shown in the form of a switching device 77. Switching device 77 is connected in series with a HALT capacitor 78 and an inductor 81. PATO circuit portion 75 includes a pulse switch 85 shown in the form of a switching device 86 connected in series with a pulse capacitor 87 and a diode (D5) 89. HALT switch 76 and Pulse switch 85 are selectively activated by controller 12. HALT/PATO circuit 50 is further shown to include a voltage snubber 93 that is connected in parallel with first MEMS switch system 40, HALT circuit portion 73, and PATO circuit portion 75. Voltage snubber 93 limits voltage overshoot during fast contact separation of first MEMS switch system 40. Voltage snubber 93 is shown in the form of a metal-oxide varistor (MOV) 94. However, it should be appreciated by one of ordinary skill in the art that voltage snubber 93 can take on a variety of forms including circuits having a snubber capacitor connected in series with a snubber resistor and/or other devices or combinations of devices that constitute a snubber,

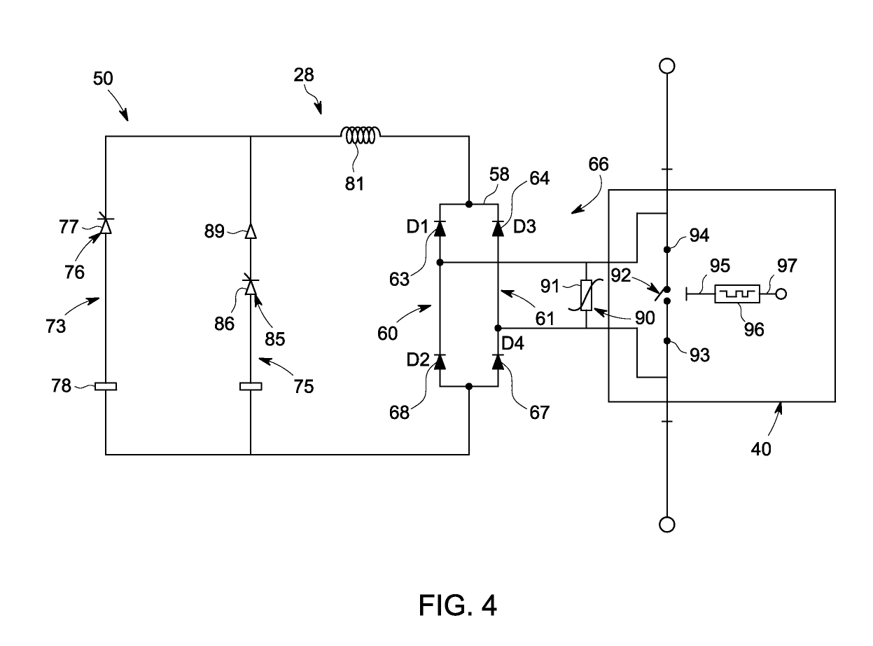

As best shown on FIG. 4, MEMS switch system 40 includes a MEMS switch 92. In the illustrated embodiment, a MEMS switch 92 is depicted as having a first connection 93, a second connection 94 and a third connection 95. In one embodiment, first connection 93 may be configured as a drain connection, second connection 94 may be configured as a source connection and third connection 95 may be configured as a gate connection. Gate connection 95 is connected to a gate driver 96. The gate driver 96 includes a power supply input (not shown) and control logic input 97 that are connected to receive signals from controller 12 and provide the means for changing the state of MEMS switch 92. It should be appreciated that while the MEMS switch 92 is illustrated as a single switch, two or more switches may be combined in parallel, in series, or some combination thereof to provide the necessary voltage and current capacity needed for the application. It should also be appreciated that MEMS switch systems 41 and 42 include similar components.

In manner similar to that described above, HALT/PATO circuit 51 includes a balanced diode bridge 100. In the illustrated embodiment, balanced diode bridge 100 includes a first branch 103 and a second branch 104. First branch 103 of balanced diode bridge 100 includes a first diode (D1) 106 and a second diode (D2) 107 coupled together. In a similar fashion, second branch 104 of balanced diode bridge 100 includes a third diode (D3) 110 and a fourth diode (D4) 111 operatively coupled together. When conducting, balanced diode bridge 58 establishes an equipotential point between a cathode (not separately labeled) of first diode (D1) 63 and a cathode (not separately labeled) of second diode (D2) 64. Of course, the equipotential point could also be between an anode (not separately labeled) of third diode (D3) 67 and an anode (not separately labeled) of fourth diode (D4) 68. The equipotential point ensures that, during opening and closing, voltage across MEMS switch system 40 remains low (e.g., less than 1 volt).

HALT/PATO circuit 51 is also shown to include a HALT circuit portion 116 connected in parallel to a PATO circuit portion 118. HALT circuit portion 116 includes a HALT switch 120 shown in the form of a switching device 121. Switching device 121 is connected in series with a HALT capacitor 122 and an inductor 125. PATO circuit portion 118 includes a pulse switch 130 shown in the form of a switching device 131 connected in series with a pulse capacitor 132 and a diode (D5) 134. HALT/PATO circuit 51 is further shown to include a voltage snubber 139 that is connected in parallel with second MEMS switch system 41, HALT circuit portion 116, and PATO circuit portion 118. Voltage snubber 139 limits voltage overshoot during fast contact separation of second MEMS switch system 41. Voltage snubber 139 is shown in the form of a metal-oxide varistor (MOV) 140. However, it should be appreciated by one of ordinary skill in the art that voltage snubber 139 can take on a variety of forms including circuits having a snubber capacitor connected in series with a snubber resistor.

In manner also similar to that described above, HALT/PATO circuit 52 includes a balanced diode bridge 144. In the illustrated embodiment, balanced diode bridge 144 includes a first branch 146 and a second branch 147. First branch 146 of balanced diode bridge 144 includes a first diode (D1) 149 and a second diode (D2) 150 coupled together. In a similar fashion, second branch 147 of balanced diode bridge 144 includes a third diode (D3) 153 and a fourth diode (D4) 154 operatively coupled together. When conducting, balanced diode bridge 58 establishes an equipotential point between a cathode (not separately labeled) of first diode (D1) 63 and a cathode (not separately labeled) of second diode (D2) 64. Of course, the equipotential point could also be between an anode (not separately labeled) of third diode (D3) 67 and an anode (not separately labeled) of fourth diode (D4) 68. The equipotential point ensures that, during opening and closing, voltage across MEMS switch system 40 remains low (e.g., less than 1 volt).

HALT/PATO circuit 52 is also shown to include a HALT circuit portion 160 connected in parallel to a PATO circuit portion 162. HALT circuit portion 160 includes a HALT switch 166 shown in the form of a switching device 167. Switching device 167 is connected in series with a HALT capacitor 168 and an inductor 170. PATO circuit portion 162 includes a pulse switch 176 shown in the form of a switching device 177 connected in series with a pulse capacitor 178 and a diode (D5) 180. HALT/PATO circuit 52 is further shown to include a voltage snubber 186 that is connected in parallel with second MEMS switch 42, HALT circuit portion 160, and PATO circuit portion 162. Voltage snubber 186 limits voltage overshoot during fast contact separation of third MEMS switch system 42. Voltage snubber 186 is shown in the form of a metal-oxide varistor (MOV) 187. However, it should be appreciated by one of ordinary skill in the art that voltage snubber 186 can take on a variety of forms including circuits having a snubber capacitor connected in series with a snubber resistor.

In further accordance with the exemplary embodiment, controller 12 includes a central processing unit 191, a memory 193, and a phase angle detector 194. Phase angle detector 194 senses a particular phase angle of each of the first, second, and third phases of multi-phase electrical source 6. For example, phase angle detection, using input from each voltage sensor 44, 45, and 46 detects a zero crossing for each phase 30, 31, and 33. Controller 12 then activates the associated one of the MEMS switch systems 40, 41, and 42 after a predetermined delay following the zero crossing. The predetermined delay may be anywhere from zero seconds up to the required time to achieve the particular phase angle for the associated MEMS switch system 40, 41, and/or 42. When each phase reaches the predetermined phase angle, controller 12 selectively sends a gate signal to close a corresponding one of the plurality of MEMS switch systems 8. By timing the activation of MEMS switch systems 8, controller 12 reduces in-rush current to each of the first, second and third MEMS switch systems 40-42, thereby reducing the in-rush current experienced by the motor starter.

In addition to setting a predetermined delay, controller 12 can be employed to reactively signal MEMS switching systems 40-41 to close at a particular phase angle. For example, phase angle detection, using input from each voltage sensor 44, 45, 46 detects a predetermined phase angle for each phase 31, 32, and 33. When the predetermined phase angle is detected, a MEMS switch gate signal is sent to close the corresponding one of MEMS switch systems 40-42. Such a reactive system is made possible by a microsecond or faster reaction time of each MEMS switch system 40-42. Such fast reaction times render turn-on delay insignificant for a 60 Hz waveform.

In accordance with one aspect of the exemplary embodiment, controller 12 activates first MEMS switch system 40 when first phase 30 reaches a first phase angle, second MEMS switch system 41 is closed when second phase 31 reaches a second phase angle and third MEMS switch system 42 closes when third phase 32 reaches a third phase angle. In accordance with one aspect of the exemplary embodiment, after first MEMS switch system 40 closes, second MEMS system 41 is closed at a voltage peak between first and second phases 30 and 31. Similarly, once second MEMS switch system 41 is closed, third MEMS switch system 42 is closed at a voltage peak between second phase 31 and third phase 32.

In accordance with an exemplary embodiment, first MEMS switch system 40 is closed at a phase angle of 0°. Second MEMS switch system 41 is closed when second phase 31 reaches a phase angle of 30°, and third MEMS switch system 42 is closed when third phase 32 reaches a phase angle of 30°. In accordance with another aspect of the exemplary embodiment, controller 12 closed first MEMS switch system 40 when first phase 30 reaches a phase angle of 0°. Second MEMS switch system 41 is closed when second phase 31 reaches a phase angle of 60°, and third MEMS switch system 42 is closed when third phase 32 reaches a phase angle of 60°. In accordance with yet another aspect of the exemplary embodiment, controller 12 closes first MEMS switch system 40 when first phase 30 reaches a phase angle of 0°. Second MEMS switch system 41 is closed when second phase 31 reaches a phase angle of 90°, and third MEMS switch system 42 is closed when third phase 32 reaches a phase angle of 90°. In accordance with still another aspect of the exemplary embodiment, controller 12 closes first MEMS switch system 40 when first phase 30 reaches a phase angle of 0°. Second MEMS switch system 41 is closed when second phase 31 reaches a phase angle of 120°, and third MEMS switch system 42 is closed when third phase 32 reaches a phase angle of 120°. In accordance with a further aspect of the exemplary embodiment, controller 12 closes first MEMS switch system 40 when first phase 30 reaches a phase angle of 0°. Second MEMS switch system 41 is closed when second phase 31 reaches a phase angle of 120°, and third MEMS switch system 42 is closed when third phase 32 reaches a phase angle of 202°.

In further accordance with an exemplary embodiment, controller 12 is preprogrammed with the phase angles of a given load. The phase angles may be selected through simulation or based on calculations from is power factor. Since motor loads are highly inductive it is desirable to close MEMS switch systems 40-42 at or near the voltage peak. The above described phase angles are relative to closing a one of the MEMS switch systems and do not require closing MEMS switch systems 40-42 in a particular order. In accordance with one example, the first phase closed would be chosen by controller 12 upon receiving a signal to close when, for example, a user presses the start button. The next phase to cross the zero point would be the first phase closed and thus remaining phases would then close at the predetermined angles of the remaining phases.

At this point it should be understood that the exemplary aspects provide a circuit that lowers long duration current that may be passed through a MEMS switch. While described in terms of MEMS switches, it should also be apparent that the exemplary embodiments can be employed to control any solid state and/or mechanical switches. Activating switches at different phase angles reduces in-rush current. The lower long duration current allows for the use of lower rated switches, or fewer switches in a switch array. More specifically, while each phase winding 20-22 of electrical motor 25 is described as being connected to corresponding phase windings 30-31 by a MEMS switch, it should be understood that the number of and type of switch could vary. That is, depending upon the voltage/current rating of the multi-phase electrical load, each phase winding could be coupled to a corresponding phase of a multi-phase electrical source by one or more switches connected in series, parallel or a series/parallel array. The particular type of switches, e.g. mechanical, solid state or MEMS is dependent upon desired design parameters. In addition, the particular phase angles at the controller activates the switches are exemplary. The controller can be programmed to activate the switches at a variety of angles depending upon voltage/current requirements for the particular switch system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A motor starter system comprising:
a plurality of switches; and
a controller operatively connected to each switch of the plurality of switches, the controller being configured and disposed to selectively activate select ones of the plurality of switches based upon a particular phase angle of each of a plurality of phases of a multi-phase electrical source.

2. The motor starter system according to claim 1, further comprising: a voltage sensor operatively connected to the controller, the voltage sensor being configured and disposed to detect a particular phase angle of each of the plurality of phases.

3. The motor starter system according to claim 1, wherein the plurality of switches include a first switch system, a second switch system, and a third switch system.

4. The motor starter system according to claim 2, wherein the controller is configured and disposed to activate the first switch system when a first phase of the multi-phase electrical source is at a first phase angle, the second switch system when a second phase of the multi-phase electrical source is at a second phase angle, and the third switch system when a third phase of the multi-phase electrical source is at a third phase angle.

5. The motor starter system according to claim 4, wherein the first phase angle is about 0°, the second phase angle is about 120°, and the third phase angle is about 202°.

6. The motor starter system according to claim 2, wherein the controller selectively activates select ones of the plurality of switches following a delay subsequent to a zero crossing of one of the plurality of phases.

7. The motor starter system according to claim 2, wherein the controller reactively activates select ones of the plurality of switches upon sensing a particular phase angle of the plurality of phases.

8. A motor system comprising:
a multi-phase load having a plurality of phase windings; and
a motor starter system operatively connected to the multi-phase load, the motor starter system including:
a plurality of switches, each switch of the plurality switches being electrically connected to respective ones of the plurality of phase windings; and
a controller operatively connected to each of the plurality switches, the controller being configured and disposed to selectively activate select ones of the plurality of switches based upon a particular phase angle of each of a plurality of phases of a multi-phase electrical source.

9. The motor system according to claim 8, further comprising: a multi-phase electrical source including a plurality of phases operatively connected to the multi-phase load and the plurality of switches.

10. The motor system according to claim 9, wherein the multi-phase electrical source includes a first phase, a second phase and a third phase.

11. The motor system according to claim 10, wherein the plurality of switches includes a first MEMS switch system electrically connected between the first phase and one of the plurality of phase windings, a second MEMS switch system electrically connected between the second phase and another of the plurality of phase windings, and a third MEMS switch system electrically connected between the third phase and still another of the plurality of phase windings.

12. The motor system according to claim 11, wherein the controller activates the first MEMS switch system when the first phase is at a first phase angle, the second MEMS switch system when the second phase is at a second phase angle, and the third MEMS switch system when the third phase is at a third phase angle.

13. The motor system according to claim 12, wherein the first phase angle is substantially identical to the second phase angle and the second phase angle is substantially identical to the third phase angle.

14. The motor system according to claim 12, wherein the first phase angle is distinct from the second phase angle and the third phase angle.

15. The motor system according to claim 14, wherein the second phase angle is substantially identical to the third phase angle.

16. The motor system according to claim 14, wherein the second phase angle is distinct from the third phase angle.

17. The motor system according to claim 16, wherein the first phase angle is about 0°, the second phase angle is about 120°, and the third phase angle is about 202°.

18. The motor system according to claim 8, wherein the controller is configured and disposed to reactively activate select ones of the plurality of switches upon sensing a particular phase angle of the plurality of phases.

19. A method of operating a motor starter system including a plurality of switches connected between a multi-phase load having a plurality of phase windings and a multi-phase electrical supply including a plurality of phases, the method comprising:
sensing a phase angle of each of the plurality of phases; and
selectively activating select ones of the plurality of switches based on a predetermined phase angle of each of the plurality of phases.

20. The method of claim 19, wherein selectively activating select ones of the plurality of switches based on a predetermined phase angle of each of the plurality of phases includes activating a first micro-electromechanical system (MEMS) switch system when a first phase of the plurality of phases is at a first phase angle, a second MEMS switch system when a second phase of the plurality of phases is at a second phase angle, and a third MEMS switch system when a third phase of the plurality of phases is at a third angle.
